(19) United States
(12) Patent Application Publication
(10) Pub. No.: US 2025/0178317 A1
(43) Pub. Date: Jun. 5, 2025

(54) SOLAR COATED LAMINATE WITH COMPLEX SHAPE AND METHOD OF MANUFACTURE

(71) Applicant: AGP WORLDWIDE OPERATIONS GMBH, Zug (CH)

(72) Inventors: Alexey KRASNOV, Northville, MI (US); José NUÑEZ-REGUEIRO, Novi, MI (US)

(21) Appl. No.: 18/725,541

(22) PCT Filed: Dec. 30, 2022
(86) PCT No.: PCT/IB2022/062938

§ 371 Date: Jun. 28, 2024

Related U.S. Application Data
(60) Provisional application No. 63/294,954, filed on Dec. 30, 2021.

(51) Int. Cl. B32B 17/10

(52) U.S. Cl. CPC B32B 17/10229; B32B 17/10036; B32B 2307/412; B32B 2307/7376; B32B 2605/00

(57) ABSTRACT

The present disclosure comprises a method for depositing a solar-control coating with silver-inclusive (Ag-inclusive) functional layers in complex shaped glazing and the laminate containing at least one such coated layer provided by the method described as follows. The coating of the present disclosure has increased flexibility allowing it to be bent to the much smaller radii of complex parts and/or withstand higher post-deposition processing temperatures.

### FIELD OF THE DISCLOSURE

The disclosure relates to the field of automotive glazing, more specifically to automotive glazing with complex shapes containing coatings.

### BACKGROUND OF THE DISCLOSURE

There are two primary technologies that are used to reduce the solar load in automotive industry, heat absorbing glass and heat reflecting coatings.

The heat absorbing glass compositions generally work by increasing the iron content, giving the glass a greenish tint. The iron compounds tend to absorb the solar energy. Unfortunately, they also reduce transmission in the visible as well as the infra-red limiting their usefulness. Roof glazing are made with visible light transmission as low as 5%. However, the windshield must transmit at least 70% of the light in the visible range. Likewise, the front door glazing and some of the other positions must also transmit 70% in the visible.

While a heat absorbing window can be very effective the glass will heat up and transfer energy to the passenger compartment through convective transfer and radiation. A more efficient method is to reflect the heat back to the atmosphere allowing the glass to stay cooler. This is done by using infrared reflecting solar-control coatings.

The Magnetron Sputtered Vacuum Deposition (MSVD) solar-control coatings achieve high reflectivity in the near infra-red by depositing silver-inclusive layers on the glass. Normally, when silver is deposited on a glass substrate, a mirror is produced with high reflectivity in the visible. By careful selection of adjacent layers, the silver is rendered transparent in the visible portion of the spectrum.

By far, the MSVD family of solar-control coatings have the best solar performance. When used in an insulated glass unit they also have low-e properties. Studies have shown that replacing a standard windshield with a coated windshield can improve fuel efficiency by 5% due to the reduction in the power drawn by the air conditioning on warm days. Even on marginally warmer days where the air conditioning is not needed, solar coated glass helps by allowing the vehicle to remain comfortable and operate with the windows closed, substantially reducing drag. Even more of an improvement is possible with coated glazing in the other positions, especially if the vehicle has a panoramic roof.

Solar-control automotive glazing, such as those utilizing a silver-inclusive thin-film coatings in automotive windshields and roofs, are known in the art having been in commercial production for over two decades and even further back for architectural glazing where the technology was first commercialized and where it today is ubiquitous.

In addition to the solar load reduction provided, the solar coating is electrically conductive and can be used to form a heated circuit for defrosting. Busbars comprised of printed silver frit, applied, and fired prior to coating or thin flat copper conductors are added to the glazing. It would be advantageous to have solar coated glazing on most vehicles and even more so on electric vehicles where range of battery operation is a concern.

Today, the production of complex shape glazing, with accentuated curvature in multiple directions and with small radii features are a key factor in the glazing industry. However, the complexity of the glazing can present challenges in implementing solar coating, as designers increasingly propose more aggressive shapes, e.g., smaller curvature radii, less than 800 mm, for enhanced aesthetics and improved aerodynamic performance. As will be discussed further in the present disclosure, these complex shapes can hinder the effective application of a solar coating.

There are various processes used to bend the glass layers configuring a glass laminate. The relatively simple windshields of the past decades, which often only had large radii curvature in one direction, were produced by means of the gravity bending process.

Gravity bending is a process in which the glass is heated to its softening temperature at which the hot soft glass can sag under the influence of gravity, to its final shape. The typical process uses a female mold that supports the glass near its periphery. The outer glass layer is placed on the mold first with the inner glass layer stack on top of it. The advantage to this process is that no contact is made with the surface of the glass during heating and forming which lessens the probability of optical defects. The main drawback is that dimensional control is not as precise as with some other bending methods. The two or more flat glass layers are both stacked onto the same mold and bent as a pair. This guarantees a good match between the two surfaces which is a required for good optics and durability.

Gravity bending was used almost exclusively for many years to bend series production windshields. While this process was simple and relatively inexpensive, it resulted in poor surface control and limited the ability to produce parts with a high level of compound curvature or small radii.

To address the need for improved surface control, the industry developed full surface and partial surface pressed laminates. Some processes involve using a full or partial surface press in conjunction with a gravity bending process. The glass is partially bent using traditional gravity bending process and then, in the final stage, the press is used to give the glass its final shape, often with the aid of air pressure and vacuum to aid compliance to the shape of the press. This process has the advantage of being adaptable to existing gravity bending process and tooling and allows the layers of the laminate to be bent in sets at the same time.

For even better surface control, singlet pressing is used. This process is similar to the process used to produce tempered parts, where the inner and outer glass layers are bent separately. Each glass ply is heated in a furnace and then pressed against a full surface press, after which the glass is transferred to a quench where it is cooled and frozen in the desired shape.

The main drawback of this process is that it has lower throughput than a comparable gravity bending line, as each glass layers must be separately rather than simultaneously as with gravity bending.

Feature lines are defined as a specific type of sharply curved portion of a vehicle glazing such as disclosed in the prior art WO2019/130283A1, WO2019/130284A1, WO2020/254991A1. The sharply curved portion of the glass may extend from one edge and progressively disappears along the surface of the glass. The sharply curved portion is obtained by locally heating by means of laser processing, the portion of the glass to a temperature sufficiently high enough to allow said portion of glass to bend. In preferred embodiments, the sharply curved portion comprises a first bent portion described by a first radius and a second bent portion described by a second radius, wherein the point where the radiuses of the first and second bent portions change their orientation generate an inflection point. The radius of curvature of the first and second bent portions is or less than 100 mm.

As mentioned above, the solar-control coating is typically deposited by magnetron sputtering, nevertheless large scale deposition can only be done on a substrate that is substantially flat. The coating is deposited on the surface of a flat glass substrate. This surface becomes an interior surface of the laminate after bending and bonding the sheet with another glass sheet into a laminated assembly.

The solar-control coating comprises at least one optically- and electrically functional member further comprising an infrared-reflecting layer, such as pure or doped metallic silver. Although other metals or metal alloys can also be used, silver is the preferred element. The silver-inclusive layers are sandwiched between at least two semiconductor or dielectric layers. The coating further comprises other optically active dielectric and/or semiconductor layers.

Most automotive and architectural high-performance solar-control glazing employ two or more sputtered silver (Ag)-inclusive nano-scale functional layers embedded into a dielectric stack. The role of each such functional layer is to enable an adequate reflection of solar radiation in the mid- and near-infrared (IR) as well as the near-ultraviolet (UV) spectral regions, while allowing a high visible transmission. An additional function of Ag-based solar-control coatings in some automotive windshields is to enable de-icing when electric current from a power supply is run through the coating.

From the mechanical standpoint, automotive solar-control laminated windshields must demonstrate a sufficient level of adhesion between individual layers of the stack as well as that of the stack itself to the substrate and laminating materials. This is important for safety reasons, i.e., to ensure the integrity of the entire glazing assembly in case of the windshield breakage.

The solar-control performance of individual silver layers is strongly influenced by the quality and material selection of adjacent layers. Typically, a thin layer of oxidized zinc-aluminum (ZnAlOx) is applied as a wetting or seeding layer on top of a relatively thick dielectric with a high index of refraction, such as titanium oxide (TiOx). Typical levels of Al concentration in the ZnAlOx wetting layer ranges between 1 and 3 wt. %. The Ag layer is deposited on top of the wetting layer, followed by the deposition of a so-called blocker, such as an ultra-thin nickel-chrome (NiCr) layer that almost completely oxidizes to NiCrOx during heat treatment. The role of the wetting layer is to provide proper crystalline properties of the silver. The role of the blocker is to encapsulate the delicate silver layer, thus protecting it from the bombardment by damaging high-energetic particles during the sputtering process. Typically, the NiCrOx blocker layer is between 1.2 nm and 3 nm.

A solar-control coating is deposited on a surface which becomes an interior surface of the laminate after bending. One of the main challenges in this process is that bending the coated flat surface to a concave shape can cause a substantial compressive stress on the coating, which can be problematic for coatings deposited by magnetron sputtering under stoichiometric conditions (compositionally balanced) as they are already under compressive stress. While it is possible to deposit the coating on the opposite surface, which will be bent to a convex shape, this is not ideal as the solar energy must pass through the plastic interlayer twice before being reflected by the coating. Additionally, newer complex shapes may have convex and concave curvature on the same side of the surface, making it difficult to apply the coating effectively.

Preserving the solar-control properties provided by infrared reflecting coatings, such as silver-inclusive solar-control coating is a must on these complex shapes. However, bending flat glass substrates pre-coated with traditional sputter-deposited silver-inclusive solar-control stacks is limited to the curvature radii of approximately 3,500 mm. At this point, the optical properties of the coating begin to deteriorate with haze increasing while visible light transmission decreases along with solar reflectance. Electrical continuity is also gradually lost making the coating unsuitable for use as a resistive heating element.

The main reason for the degradation is the poor bendability of the coating. The coating tends to be very brittle and tends to fracture and buckle due to the highly crystalline films of the stack, particularly the ZnAlOx.

Each of the silver-inclusive layers typically requires two ZnAlOx layers: an under-coat that the silver layer is deposited over and an over-coat of ZnAlOx applied over the silver layer. While silver is a very malleable metal at the macro level, the nano-scale crystalline silver layers themselves are also brittle.

While there are other materials that can be used, ZnAlOx remains the material of choice due to its superior wetting (under-layer) and opto-mechanical (over-coat) and compatibility with the silver. The other layers of the stack, such as amorphous optical layers, are less of a concern. They bend reasonably well at high curing (bending) temperatures.

However, one of the other challenges of bending coated glass is the susceptibility of the coating to degradation at high temperatures. Silver is a very active element and tends to migrate and form dendrites at elevated temperatures, which can be a problem with even non-complex shapes. This issue is further exacerbated at the higher temperatures required to bend complex shapes. Even at lower bending temperatures, the silver layer can deteriorate if held at the elevated temperature for too long. This has limited the use of solar coatings to shapes that can be bent without requiring high bending temperatures or extended periods of time to reach the targeted shape.

It would be desirable to have a method of bending glass sheets pre-coated with a silver-inclusive solar-control layer stack to complex shapes with a small minimum curvature radius. This would allow the use of the existing manufacturing platform of large-area magnetron-sputtering vapor deposition (MSVD) and the related production infrastructure to meet the growing needs of the automotive glazing industry.

It would also be desirable to achieve both good solar performance and high light transmission in the visible with such a coating within a complex laminate.

### BRIEF SUMMARY OF THE DISCLOSURE

The present disclosure relates to a method for depositing a solar-control coating with silver-inclusive (Ag-inclusive) functional layers in complex shape glazing and to the resulting laminate containing at least one coated layer.

The coating of the present disclosure is of high value when applied to curved glass parts with (small curvature radii); yet more specifically, to curved glass parts having areas with small curvature radii that require a solar-control coating. The solar-control coating is designed in such a way as to be compatible with post-deposition glass-bending process to achieve a minimum curvature radius of as little as 1000 mm or less. The application of the curved assembly is not limited to automotive glazing and can be extended, e.g., to rail, transit, aerospace, architectural, military, etc.

As shown in FIG. 5, a glass substrate is provided wherein a first thick dielectric layer comprises any of the following: SiOx, SiOxNy, TiOx, or their combinations, ranging in total thickness from 10 nm to 140 nm is deposited for optical purposes. On top of a first dielectric layer a ZnAlOxNy under-coat wetting layer, ranging in thickness between 4 nm and 25 nm, is deposited by sputtering ZnAlOx with the addition of nitrogen reactive gas wherein the detectable amount of nitrogen dissolved in the final ZnAlOx layer after heat treatment is at least 1,000 ppm which results in the formation of as-deposited ZnAlOxNy, also described as substantially amorphous ZnAlOxNy layer.

A silver-inclusive functional layer is deposited over the under-coat wetting layer with an increased argon sputter pressure.

An ultra-thin blocker layer consisting of NiCrOx is deposited on top of the Ag-inclusive functional layer to form a barrier layer that protects the functional layer from the high energy particles of the over-coat layer during deposition. The blocker layer should have a thickness between 1 nm and 3 nm. Optionally two ultra-thin blocker layers could be deposited in such a way that they sandwich the Ag-inclusive layer. The combination of Ag-inclusive layer with the ultra-thin blocker layer is also called Ag-inclusive functional layer.

A ZnAlOxNy over-coat layer is then deposited above the silver-inclusive functional layer and the blocker layer by sputtering ZnAlOx with the addition of nitrogen reactive gas resulting in the formation of ZnAlOxNy. The over-coat layer may range in thickness between 4 and 25 nm.

A second thick dielectric layer stack is deposited over the over-coat layer and is comprised of any of the following dielectrics or their combination: SiOx, SiOxNy, ZnSnOx, ZnTiOx, ZnZrOx, ZrTiOx and ranging in total thickness between 30 nm and 200 nm.

For solar-control coatings with more than one functional layers, such as 2-Ag (double silver), 3-Ag (triple silver) or 4-Ag (quad-silver) layers, the layer stack sequence as described above should be repeated accordingly. In additional embodiments, such as that shown in FIG. 6, when more than 1 functional layers are present, the dielectric layer stack that is deposited over the over-coat layer is selected from the group comprising ZnSnOx, ZnTiOx, ZnZrOx and ZrTiOx. In any case the top layer of the stack coating sequence is selected from the group comprising SiOx, SiOxNy, ZnSnOx, ZnTiOx, ZnZrOx, ZrTiOx, preferably SiOx.

The disclosed method results in a less ordered, more amorphous, and thus more tensile silver-inclusive layer. The amorphous nature of the silver-inclusive layer is enhanced by the as-deposited amorphous ZnAlOxNy wetting layer leading to its much better bendability compared to the layers deposited at moderate sputter pressures and on a crystallized ZnAlOx wetting layer.

The silver-inclusive layer also has improved heat resistance. Silver is a very active element. When the thin silver layer is heated the silver tends to migrate and even to form dendrites. By starting out at a less ordered amorphous state, the silver can be heated to higher temperatures and/or for a longer time without damage to the silver.

The list of advantages of the present disclosure include, but are not limited to:
Better suitability for complex surfaces such as high glass curvature;
Lower haze;
Improved solar properties;
Improved optical properties;
Electrical continuity maintained;
Able to withstand higher bending temperatures.

### BRIEF DESCRIPTION OF THE DRAWINGS

FIG. 1A shows the cross section of a typical laminated automotive glazing.

FIG. 1B shows the cross section of a typical laminated automotive glazing with performance film and coating.

FIG. 1C shows the cross section of a typical tempered monolithic automotive glazing.

FIGS. 2A and 2B show the explanation of a compressive stress imposed onto a coating stack on surface 2 during bending.

FIGS. 3A and 3B show a Transmission Electron Microscopy image of the structure of a silver film. The structure of a silver thin film sandwiched between two ZnAlOxNy (when as-deposited) layers with: a) y=0 (ZnAlOxNy) and b) y=0.08. ZnAlOxNy converts into ZnAlOx during high temperature bending with nitrogen being trapped within the boundaries of the layer.

FIG. 4 shows a side view of a panoramic windshield having a minimum radius of curvature of 800 mm.

FIG. 5 shows a schematic representation of one functional layer 1-Ag solar-coating stack deposited on a glass.

FIG. 6 shows a schematic representation of two functional layers 2-Ag solar-coating stack deposited on a glass.

### REFERENCE NUMERALS OF DRAWINGS

2 Glass.
4 Bonding/Adhesive layer (plastic Interlayer).
6 Obscuration/Black Paint.
18 Infrared reflecting coating.
101 Exterior side of glass layer 1 (201), number one surface.
102 Interior side of glass layer 1 (201), number two surface.
103 Exterior side of glass layer 2 (202), number 3 surface.
104 Interior side of glass layer 2 (202), number 4 surface.
201 Outer glass layer.
202 Inner glass layer.

### DETAILED DESCRIPTION OF THE DISCLOSURE

The present disclosure can be understood more readily by reference to the detailed descriptions, drawings, examples, and claims in this disclosure. However, it is to be understood that this disclosure is not limited to the specific compositions, articles, devices, and methods disclosed unless otherwise specified, as such can, of course, vary. It is also to be understood that the terminology used herein is for the purpose of describing aspects only and is not intended to be limiting.

The structure of the present disclosure is described in terms of the layers comprising the glazing. The meaning of “layer”, as used in this context, shall include the common definition of the word: a sheet, quantity or thickness, of material, typically of some homogeneous substance and one of several. It also should be noted that the layers are generally substantially even and continuous at least at the macro level.

A layer may further be comprised of non-homogeneous and also of multiple layers as in the case of a multi-layer coatings such as a solar coating. When multiple layers together provide a common function, the multiple layers may be referred to as a layer even if the multiple layers comprising the layer are not adjacent to each other. An example would be a solar protection layer comprising: a solar absorbing glass inner glass layer and a solar reflecting coating applied to the outer glass layer.

A typical laminated windshield comprises two glass layers and a plastic interlayer. An interlayer layer is generally of the same area as the glass layers. The typical laminate may further comprise additional layers including but not limited to coatings and films. The surface area of a layer may be substantially less than that of the glazing. A film layer will have a smaller area than the glass. An obscuration layer will have an area that is substantially less than that of the glass.

Other types of material and components may also be included within the structure. A lighting or heating circuit may be referenced respectively as the lighting layer or the heating layer even though the layer comprises multiple separate components rather than a substantially flat homogeneous sheet of material. In this case, the reference is to the position within the thickness in much the same way that we would reference the floor of a building.

When multiple layers that vary widely in thickness are illustrated, it is not always possible to show the layer thicknesses to scale without losing clarity.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Most of the glass used for containers and windows is soda-lime glass. Soda-lime glass is made from sodium carbonate (soda), lime (calcium carbonate), dolomite, silicon dioxide (silica), aluminum oxide (alumina), and small quantities of substances added to alter the color and other properties.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Laminated safety glass is made by bonding two layers of annealed glass together using a plastic bonding layer comprised of a thin sheet of transparent thermoplastic.

The plastic bonding layer (interlayer) has the primary function of bonding the major faces of adjacent layers to each other. The material selected is typically a clear thermoset plastic. For automotive use, the most used bonding layer (interlayer) is polyvinyl butyral (PVB). Automotive grade PVB has an index of refraction that is matched to soda-lime glass to minimize secondary images caused by reflections at the PVB/Glass interface inside of the laminate.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer also helps to prevent penetration by objects striking the laminate from the exterior and in the event of a crash occupant retention is improved.

The list of coating layers is called the coating stack. When describing a coating stack, we shall use the convention of numbering the coating layers in the order that they are deposited upon the substrate. Also, when discussing two layers, the one closest to the substrate shall be below or under the second layer. The layer furthest from the substrate is over or above the second layer. Likewise, the top layer is the very last layer applied and the bottom layer is the very first layer deposited upon the substrate. The top of an individual layer is the side of the layer furthest from the substrate while the bottom is closest to the substrate.

Infrared reflecting solar-control coatings include but are not limited to the various metal/dielectric layered coatings applied through Magnetron Sputtered Vacuum Deposition (MSVD) as well as others known in the art that are applied via pyrolytic, spray, controlled vapor deposition (CVD), dip and other methods.

Solar coatings are very fragile and easily damaged. They are generally too soft to be applied to a glass surface exposed to the exterior surface facing the elements. They must be applied to one of the interior laminate surfaces where the coating is protected. While the coating can be applied to the interior face of the outer glass layer (also known as surface two) or the exterior face of the inner glass layer (known as surface three), it is preferable to coat surface two. This is because if surface three is coated, the solar energy will need to pass through the interlayer to the coating and then be reflected passing through the interlayer a second time. This results in a measurable drop in efficiency. The interlayer is also formulated to absorb all of the ultraviolet.

A variety of terms are used to describe the performance of a solar-control coated glazing and its visible light transmission. The Solar Heat Gain Coefficient (SHGC) is the ratio of the solar radiation that passes through a glazing to the incident solar radiation. The SHGC has a range of zero to one with zero being no heat transferred and one-all of the heat transferred. Visible transmittance (VT) is a measure of how much light, in the visible portion of the spectrum, passes through a glazing. The Light-to-Solar Gain (LSG) is the ratio of the SHGC to the VT. A double silver coating, for instance, has an LSG in the range between 1.6 and 2, while a triple-Ag coating's LSG is more than 2.2. Haze is a measure of how much light is scattered by a transparent material. Automotive laminates will typically have a haze of less than 2% and preferably as low as possible. Some performance films, interlayers and coatings will increase the haze.

While the focus of the embodiments and discussion is laminated windshields and roofs for vehicles, it can be appreciated that the present disclosure is not only applied to the automotive industry by also to nautical, aircraft, and railway applications among others. The present disclosure may be implemented in any of the other glazing positions in the vehicle.

The following terminology is used to describe the laminated glazing of the present disclosure.

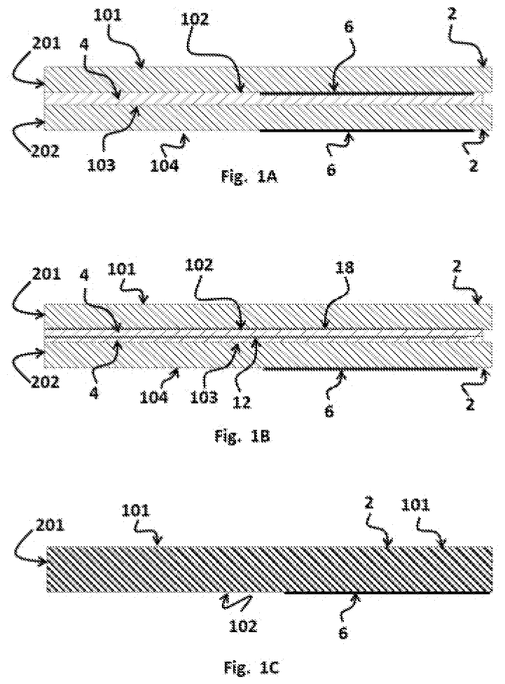

Typical automotive laminated glazing cross sections are illustrated in FIGS. 1A and 1B. A laminate is comprised of two layers of glass, the exterior or outer, 201 and interior or inner, 202 that are permanently bonded together by a plastic bonding layer 4 (interlayer). In a laminate, the glass surface that is on the exterior of the vehicle is referred to as surface one, 101, or the number one surface. The opposite face of the outer glass layer 201 is surface two, 102, or the number two surface. The glass 2 surface that is on the interior of the vehicle is referred to as surface four, 104, or the number four surface. The opposite face of the inner layer of glass 202 is surface three, 103, or the number three surface. Surfaces two, 102, and three, 103, are bonded together by the plastic bonding layer 4. An obscuration 6 may be also applied to the glass. Obscurations are commonly comprised of black enamel frit printed on either the number two, 102, or number four surface, 104, or on both. The laminate may have a coating 18 on one or more of the surfaces. The laminate may also comprise a performance film 12 laminated between at least two plastic bonding layers 4.

FIG. 1C shows a typical tempered automotive monolithic glazing cross section, in which the tempered glass 201 has been strengthened. It should be noted that the glass layers may be strengthened by various methods, including but not limited to heat strengthening and chemical strengthening. In the embodiment of FIG. 1C, the glass surface that is on the exterior of the vehicle is referred to as surface one, 101, or the number one surface. The opposite face of the exterior glass layer 201 is surface two, 102, or the number two surface. The number two surface, 102, of a tempered glazing is on the interior of the vehicle. An obscuration 6 may be also applied to the glass. The glazing may have a coating 18 on the number one, 101, and/or number two, 102, surfaces (not illustrated).

One of the key features of the present disclosure is that it reduces the brittleness of the sensitive areas of a silver-inclusive solar-control stack deposited on a glass surface, enabling the glass to be bent to small curvature radii (for instance, 200 mm) without breaking or cracking. In preferred embodiments, the coating of the disclosure may be particularly deposited in surface two 102 or surface three 103 of the glass, with surface two 102 being the most preferable surface.

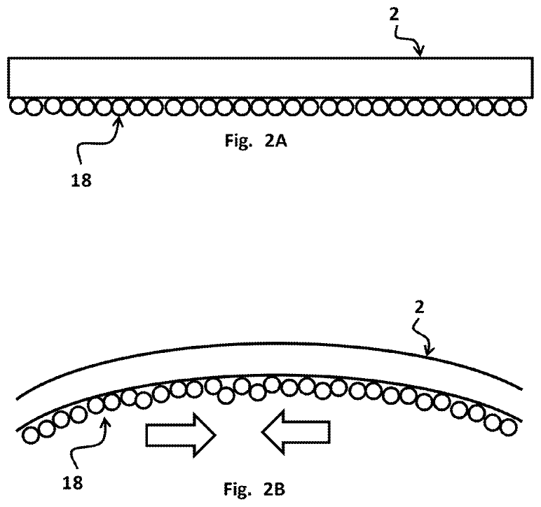

Particularly, the present disclosure focuses on making the ZnAlOx and the Ag-inclusive layers of the stack less compressive (more tensile) to avoid being cracked during bending under an additional compressive stress (as illustrated in FIGS. 2A and 2B). This is achieved by: adding nitrogen reactive gas (the ratio of oxygen-to-nitrogen flow is between 10 and 20) to achieve ZnAlOxNy composition of under- and over-coat for each of the Ag-inclusive functional layers. The detectable amount of nitrogen in the ZnAlOx layer after heat treatment is at least 1,000 ppm.

The ZnAlOxNy produces an amorphous as-deposited film with a tensile stress and a great bendability. The layer turns into a highly transparent and crystalline ZnAlOx by the end of the high-temperature curing (bending) process. Traces of isolated (unbound) nitrogen can be detected (reverse engineered) within the final ZnAlOx layers, thus indicating the use of nitrogen during the layer deposition.

Each silver-inclusive layer is deposited on a ZnAlOxNy wetting layer at an increased argon (Ar) sputter pressure having a ratio of the electric power on a silver sputtering cathode to a total argon flow in a typical deposition of a silver layer varies between 0.025 and 0.1 KW/sccm, with a preferred range between 0.03 and 0.05 KW/sccm. The coating stack disclosed in the present disclosure uses an increased Ar pressure which results in the power-to-flow ratio of equal or less 0.05 KW/sccm. Said silver-inclusive functional layer is comprised of Ag metallic or an alloy of Ag with at least one of the following elements Al, Ti, Cu, Au and Pt.

The increased sputter pressure during the Ag-inclusive layer deposition ensures the arrival to the substrate of high-kinetic-energy chaotic particles from the silver target. These particles form a less ordered (more amorphous and, thus, more tensile) silver layer. The amorphous nature of an as-deposited Ag film, also enhanced by depositing it on amorphous ZnAlOxNy wetting layer, leads to its much better bendability compared to the layers deposited at moderate sputter pressures and on a crystallized ZnAlOx wetting layer.

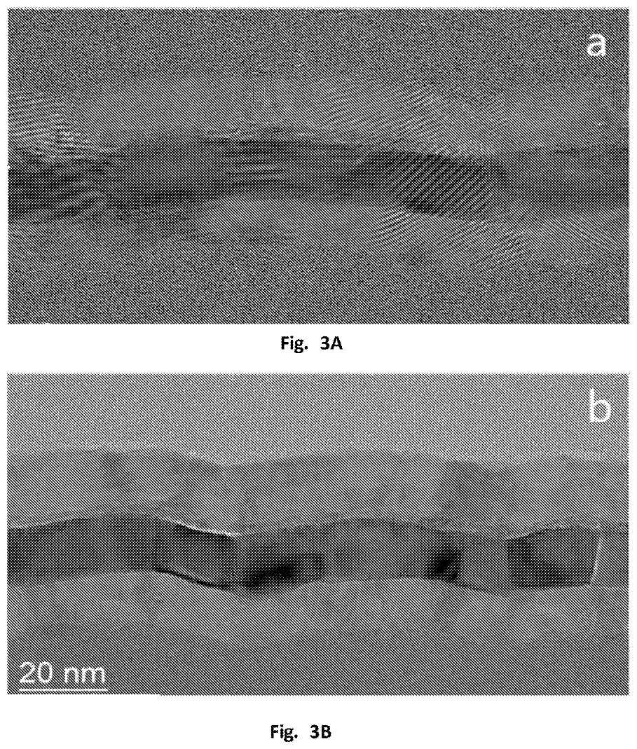

By the end of the bending process, the amorphous ZnAlOxNy turns into the crystalline ZnAlOx, and the Ag layer crystallizes on it, forming a characteristics structure consisting of distinct ‘blocks’ (FIG. 3A) as compared to a more ‘traditional’ appearance of Ag deposited on a ZnAlOx wetting layer (FIG. 3B). Each silver-inclusive layer consisting of the ‘blocks’ provides the same solar control properties as a regular Ag layer due to the fact that the plasmonic oscillations at infrared resonance frequencies act within short ranges and do not require long-range continuity of electrical conductivity.

The solar-coating stack of the disclosure is suitable for complex shape glazing, such as glazing with accentuated curvature in multiple directions and with small radii features, such radii are less than 3,500, preferable less than 2,000, preferable less than 1,000 mm, preferable less than 800 mm, preferable less than 600 mm, preferable less than 500 mm, preferable less than 400 mm, preferable less than 200 mm. In the same manner, while the focus has been on complex shapes with small radii curvature, the coating may be applied to less complex and or substantially flat glass or glass laminates.

An alternate implementation for the coat wetting layer, it is deposited zinc nitride—as an amorphous layer and then converting it to ZnOx. In this case, in the ZnAlOxNy formula, x=0 for as-deposited material (i.e., ZnAlNy). After heat treating, the layer becomes ZnAlOxNy with x>0 and y≥0 (i.e., ZnAlOx or ZnAlOxNy).

### EMBODIMENTS

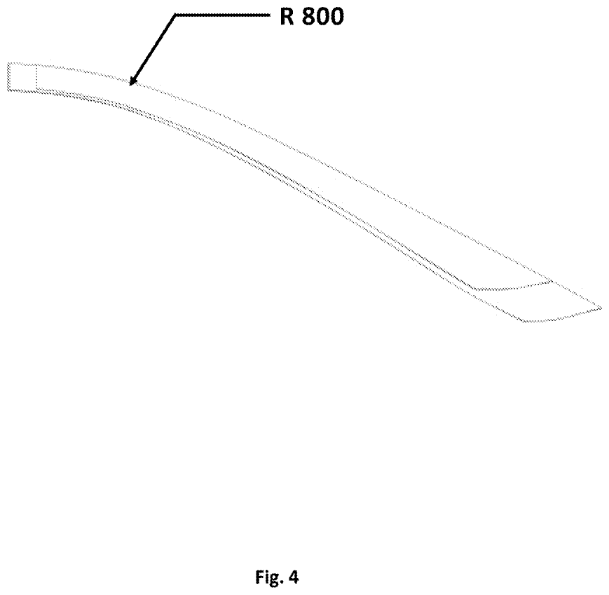

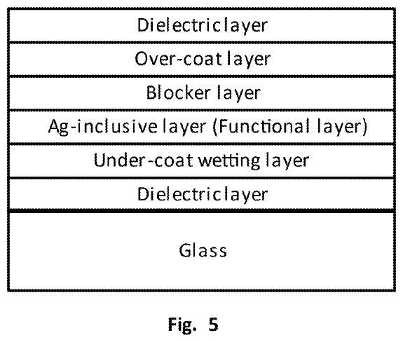

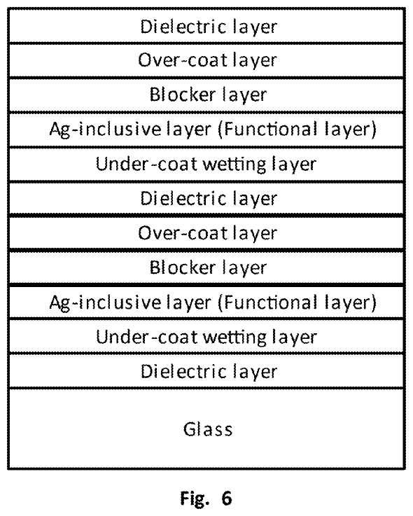

1. Embodiment one is a solar-control coating deposited over a portion of a glass substrate. Such coating is formed by multiple layers forming a stack and comprises the following composition starting from the glass substrate in the following order:
   a first thick dielectric layer comprised of any of the following: SiOx, SiOxNy, TiOx, or their combinations, ranging in total thickness from 10 nm to 140 nm;
   a first under-coat wetting layer comprised of as-deposited (substantially amorphous) ZnAlOxNy, ranging in thickness between 4 nm and 25 nm;
   a first thin Ag-inclusive layer pure or alloyed with Al, Cu, Au, Pt, Ti, or any of their combination and ranging in thickness between 7 and 25 nm;
   a first ultra-thin blocker layer comprised of NiCrOx with thickness between 1 nm and 3 nm;
   a first over-coat layer comprised of substantially amorphous ZnAlOxNy, ranging in thickness between 4 nm and 25 nm; and
   a second thick dielectric layer stack comprised of any of the following dielectrics or their combination: SiOx, SiOxNy, ZnSnOx, ZnTiOx, ZnZrOx, ZrTiOx and ranging in total thickness between 30 nm and 200 nm.
   After the second thick dielectric layer stack the coating layers may be repeated starting from the under-coat layer and followed by the subsequent layers to form not only a 1-Ag solar-control coating stack, but also a 2-Ag, 3-Ag, or even a 4-Ag solar-control coating stack.
2. Embodiment two is a laminate glazing comprising two glass layers, an outer and an inner glass layers. The outer glass layer is the glass substrate of embodiment one with the solar-control coating deposited onto surface two. The outer glass layer with the coating as well as the inner glass layer are heat-bent at the same time the coating applied on surface two of the outer glass layer is heat treated. After the bending process, the coating's under-coat wetting and over-coat layers as well as the Ag-inclusive layer are crystallized. The curved glass layers are laminated together using a plastic bonding layer.
3. Embodiment three is the laminate of embodiment two, wherein the glazing comprises a large panoramic roof measuring 1,200 mm by 800 mm. The front and rear portions of the roof meet the windshield and backlite respectively where the laminate curvature has a radius of approximately 500 mm maintaining geometric continuity with the windshield and the backlite.
   The roof is a laminate with a 3.2 mm soda-lime clear outer glass layer 201 and a 2.3 mm thick solar green inner layer. A single layer of 0.76 dark grey PVB plastic bonding layer with a total visible light transmission of 20% is used to bond the glass layers to each other. Both glass layers are screen printed with a black frit obscuration. The black frit is printed on surfaces two and four. After painting and firing the black frit on the outer glass layer, the solar-control coating stack of embodiment one, with two silver-inclusive layers, is applied by means of an MSVD coater. The silver-inclusive layers are deposited with an argon sputter pressure having a ratio of electric power on the silver sputtering cathode to a total argon flow in the range of 0.025 and 0.1 kW/sccm, with a preferred range between 0.03 and 0.05 KW/sccm.
   The silver-inclusive layers protected by ultra-thin blocker layers are each sandwiched between ZnAlOxNy layers formed by sputtering ZnAlOx with the addition of nitrogen reactive gas resulting in the formation of ZnAlOxNy. The glass layers are press-bent to shape and laminated.
4. Embodiment four is the laminate of embodiment two, wherein the glazing is the large panoramic windshield shown in FIG. 4 with an area of two square meters. The top of the windshield extends into the roof line by over 0.3 meters. The portion of the windshield where the windshield transition into the roof line has a radius of curvature of 800 mm. The A-pillar sides of the windshield have a minimum radius of curvature of 1,000 mm. The outer glass layer 201 is 2.3 mm thick borosilicate glass. The inner glass layer 201 is chemically tempered 1.0 mm thick aluminosilicate glass.
   A clear PVB with a wide dark tint shade band extended to the top edge from the top of the vision zone is used to bond the two glass layers in the autoclave.
   Both glass layers are screen printed with a black frit obscuration. The black is printed on surfaces two, 102, and four, 104.
   After painting and firing of the black frit on the outer glass layer 201, the solar-control coating stack of embodiment one, with three silver-inclusive functional layers is applied by means of an MSVD coater to surface two 102. The silver-inclusive layers are sputter with an argon sputter pressure having a ratio of electric power on the silver sputtering cathode to a total argon flow in the range of 0.025 and 0.1 kW/sccm, with a preferred range between 0.03 and 0.05 KW/sccm.
   The silver-inclusive layers and their corresponding ultra-thin blocker layers are each sandwiched between ZnAlOxNy layers formed by sputtering ZnAlOx with the addition nitrogen reactive gas resulting in the formation of ZnAlOxNy. The glass layers are bent to shape and laminated. After lamination, the total visible light transmission of the laminate is 72% and the LSG is 1.65.
5. Embodiment five is similar to embodiment four. Bus bars are screen printed over the dried black frit on surface two and the glass is heat treated prior to coating. Flexible connectors are used to make the electrical connection to the coating. At 42 volts the windshield draws 600 watts per square meter.
6. Embodiment six is similar to embodiment four. However, zinc nitride is deposited as a substantially amorphous layer and then converted it to ZnOx during heat treatment. In this case, in the ZnAlOxNy formula, x=0 for as-deposited material (i.e., ZnAlNy). After heat treating, the layer becomes ZnAlOxNy with x>0 and y≥0 (i.e., ZnAlOx or ZnAlOxNy).
7. Embodiment seven is the laminate of embodiment two, wherein the glazing is a 1,200 mm×800 mm laminated window for a military vehicle. The horizontal curvature has a radius of 8,000 mm. In the vertical the glass has a radius of curvature of 5,000 mm. The outer glass layer 201 is comprised of 6 mm borosilicate glass. The inner glass layer 202 is comprised of 4 mm soda lime clear glass. The two glass layers are laminated with a heat absorbing PVB as the plastic bonding layer 4. The two glass layers are bent together by means of a gravity bending process on a ring mold. Due to the glass composition and the thickness, an extended bending cycle at a higher temperature than used for the typical automotive windshield is required. Surface two, 102, of the outer glass layer 201 is coated with the solar-control coating of embodiment one.

It must be understood that the present disclosure is not limited to the embodiments described and illustrated, as it will be obvious for an expert on the art, there are different variations and possible modifications that do not strive away from the disclosure's essence, which is only defined by the following claims.

1. A method for the deposition of a solar-control coating over a portion of at least a glass substrate for automotive applications, the method comprising the following steps:
providing at least one glass layer having two oppositely major surfaces;
depositing a first thick dielectric layer of any of the following SiOx, SiOxNy, TiOx, or their combinations;
depositing a layer of oxidized zinc-aluminum with the addition of nitrogen reactive gas forming a first under-coat wetting layer comprising ZnAlOxNy through Magnetron Sputtered Vacuum Deposition (MSVD);
depositing a first thin Ag-inclusive layer;
depositing a first ultra-thin blocker layer comprised of NiCrOx;
depositing a first over-coat layer comprised of ZnAlOxNy with the addition of nitrogen reactive gas forming ZnAlOxNy through Magnetron Sputtered Vacuum Deposition (MSVD);
depositing a second thick dielectric layer stack comprised of any of the following dielectrics or their combination: SiOx, SiOxNy ZnSnOx, ZnTiOx, ZnZrOx, ZrTiOx; and
heating said coated substrate to the glass transition range.

2. The method of claim 1, wherein more than one functional layer is included, more specifically, a 2-Ag (double silver), 3-Ag (triple silver) or 4-Ag (quad-silver).

3. The method of claim 1, wherein the solar coating stack sequence is repeated to include more functional layers.

4. The method of claim 1, further comprising the addition of nitrogen reactive gas during the step of depositing the first over-coat ZnAlOxNy layer, wherein the detectable amount of nitrogen in the ZnAlOxNy layer after heat treatment is at least 1,000 ppm, and wherein the ratio of oxygen to nitrogen flow is between 10 and 20.

5. The method of claim 1, wherein the silver-inclusive layer is deposited with an increased argon sputter pressure having a ratio of electric power on the silver sputtering cathode to a total argon flow between 0.025 and 0.1 kW/sccm; preferably between 0.03 and 0.05 kW/sccm.

6. (canceled)

7. The method of claim 1, wherein the surface of the glass substrate can be selected from the group of flat, curved, substantially flat or the combination thereof.

8. An automotive laminated glazing, comprising:
at least two glass layers, each glass layer having two major faces;
at least one transparent plastic bonding layer located between the at least two glass layers; and
a solar-control coating deposited by MSVD over a portion of one of said glass layers and in direct contact with said plastic bonding layer, wherein the coating is formed by a stack of multiple layers comprising starting from the glass in the following order:
a first thick dielectric layer comprised of any of the following: SiOx, SiOxNy, TiOx, or their combinations;
a first under-coat wetting layer comprised of ZnAlOxNy;
a first thin Ag-inclusive layer;
a first ultra-thin blocker layer comprised of NiCrOx;
a first over-coat layer comprised of ZnAlOxNy; and
a second thick dielectric layer stack comprised of any of the following dielectrics or their combination:
SiOx, SiOxNy; ZnSnOx, ZnTiOx, ZnZrOx, ZrTiOx.

9. The laminated glazing of claim 8, wherein the first thick dielectric layer has a total thickness ranging from 10 to 140 nm.

10. The laminated glazing of claim 8, wherein the first thin Ag-inclusive layer is pure or alloyed with Al, Cu, Au, Pt, Ti, or any of their combination and has a thickness ranging between 7 and 25 nm.

11. The laminated glazing of claim 8, wherein the first ultra-thin blocker layer comprised of NiCrOx has a thickness ranging between 1 and 3 nm.

12. The laminated glazing of claim 8, wherein the first over-coat layer comprised of ZnAlOxNy has a thickness ranging between 8 and 25 nm.

13. The laminated glazing of claim 8, wherein the second thick dielectric layer has a total thickness ranging from 30 and 200 nm.

14. The laminated glazing of claim 8, wherein more than one functional layers, such as 2-Ag (double silver), 3-Ag (triple silver) or 4-Ag (quad-silver) layers are included.

15. (canceled)

16. The laminated glazing of claim 8, wherein glazing has a total visible light transmission of at least 70%.

17. The laminated glazing of claim 8, wherein the solar-control coating has a Light-to-Solar Gain of at least 1.6.

18. The laminated glazing of claim 8, wherein the as-deposited over and under-coat layers of said solar-control coating has x=0 in the ZnAlOxNy formula.

19. The laminated glazing of claim 8, wherein the surface of the glass layers can be selected from the group of flat, curved, substantially flat and a combination thereof.

20. The laminated glazing of claim 8, wherein the minimum curvature radius of the laminate is less than 3,500 mm, less than or equal to 2000 mm, less than or equal to 1,500 mm, less than or equal to 1,000 mm, or is less than or equal to 500 mm.

21. The laminated glazing of claim 8, wherein the first under-coat wetting layer has a thickness ranging between 4 nm and 25 nm.

22. The laminated glazing of claim 8, wherein the detectable amount of nitrogen dissolved in the final ZnAlOx layer after heat treatment is at least 1,000 ppm.
